(19) United States
(12) Patent Application Publication
(10) Pub. No.: US 2005/0120140 A1
(43) Pub. Date: Jun. 2, 2005

(54) Method of and system for multi-patch communication

(76) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/507,334

(22) PCT Filed: Feb. 12, 2003
(86) PCT No.: PCT/IB03/00570

(30) Foreign Application Priority Data
Mar. 14, 2002 (EP) 02076032.8

(51) Int. Cl. G06F 15/16

(52) U.S. Cl. 709/249; 709/203; 709/235

(57) ABSTRACT

The invention relates to a method of and to a system (1000) for dealing with network congestion. A first internet-working device (100) may have several paths available (110; 120) for accessing a second device (400) through a network (AN1; AN2). The first device may e.g. have a low-bandwidth connection that is always operational and/or a high-bandwidth connection which is only operational when the device in its docking station. The basic concept of the invention is embodied in a splitter/merger device (130) that proxies a connection (1), such as a TCP-connection, splits the connection (1) into multiple separate connections (2, 3) which are available, and routes packets (140) over these multiple connections to an external splitter/merger component (200). The splitter/merger device (130; 134; 142; 144; 152) divides the packets over the available connections in dependence of the progress of transport along each of these connections (2, 3). The functions of the splitter/merger components (130; 200) are symmetric and mirrored if there is both incoming (620; 140, 600) and outgoing (140; 500, 620) traffic.

The present invention relates to a method of speeding up a relay operation across an internetworking connection, such as a TCP-connection, between a client device in a first location and a server device in a second location in a network which comprises multiple access nodes or communication paths between said client and server devices, which method comprises the use of a command protocol hosted by a controlling component. The invention also relates to a system which is suitable for implementing said method.

Time delays created by slow links as data travels across various nodes in a network is a recurring problem. This is known as latency. There are several solutions known in the prior art for dealing with high latency. One solution is by means of a split proxy system that encapsulates TCP/IP transmissions into a script transmission which is not subject to problems in high-latency systems. A disadvantage of this solution is that the increased robustness of a suitable script transmission is subject to limited throughput of a low-bandwidth communication path.

Another known solution entails doing away with an application-layer server to exchange data between the client-to-proxy and proxy-to-server sections of a split TCP-connection and mapping the byte stream arriving at one end of the split connection directly into the sequence number space of the other end of the split connection. This solution too is subject to limited throughput of a low-bandwidth communication path.

Yet another known solution prevents unnecessary degradation of TCP throughput by recovering only the portions of packets which are actually lost, e.g. an air link time frame in wireless communication, instead of recovering the larger TCP packets. This solution has the disadvantage that it leads to quenching of the TCP source window if a long disconnection is predicted.

It is an object of the present invention to handle congestion in a communication path in packet-switching systems.

It is another object of the invention to provide for a method which entails achieving an appropriate balance between a flow control mechanism and a congestion control mechanism in communication protocols. It is a further object to provide for a system which is suitable for implementing such a method.

According to one aspect of the invention one or more of the stated objects are achieved by a method of speeding up a relay operation across an internetworking connection, such as a TCP-connection, according to claim 1.

The basic novel and inventive concept is to make use of the bandwidths of multiple access networks for a single connection, with appropriate transfer of the single connection as a device switches between different access networks. The related technical advantage is that this allows use of all the available hardware bandwidth for devices in networks which comprise multiple access nodes or communication paths. Also, connections do not have to be discontinued or broken and subsequently reconstituted as a device switches between different access networks. This also enhances the operational reliability.

An embodiment of the method according to the invention makes it possible that, for example, a laptop computer with both a wireless network card and a wired connection can combine the bandwidths of both networks to stream an audio/video file across the internet. Also, if the laptop computer has e.g. a TCP connection over the wired connection, then the TCP connection can be transferred to the wireless access network without breaking the connection.

In a preferred embodiment of the method according to the invention, it comprises an operation of monitoring the bandwidths over a number of access networks available to the client device with respect to the merging/splitting component on the internet. More preferably, the method also comprises an operation of responding to any change in the available bandwidth by generating control instructions for switching the connection at the client end for making maximum use of the available bandwidth. This is advantageous in that it allows for the use of refined algorithms and efficient transmission, retransmission and switching operations.

In another further embodiment, there are multiple operations for merging the streams of packets originating from the server device through a number of IP addresses at the merging/splitting component on the internet and for splitting the traffic in the reverse direction. This, too, offers the advantage of high-speed traffic.

The invention also relates to a splitting/merging device suitable for use with said method of speeding up a relay operation across an internetworking connection, and to a computer programme comprising instructions for operating the splitting/merging device. Further, the invention also relates to a system comprising a splitting/merging means in the server device in the first location and a splitting/merging device on the internet according to claim 7, which system is suitable for implementing the method according to the invention.

These and other aspects of the invention will be apparent from and elucidated with reference to the embodiment(s) described hereinafter.

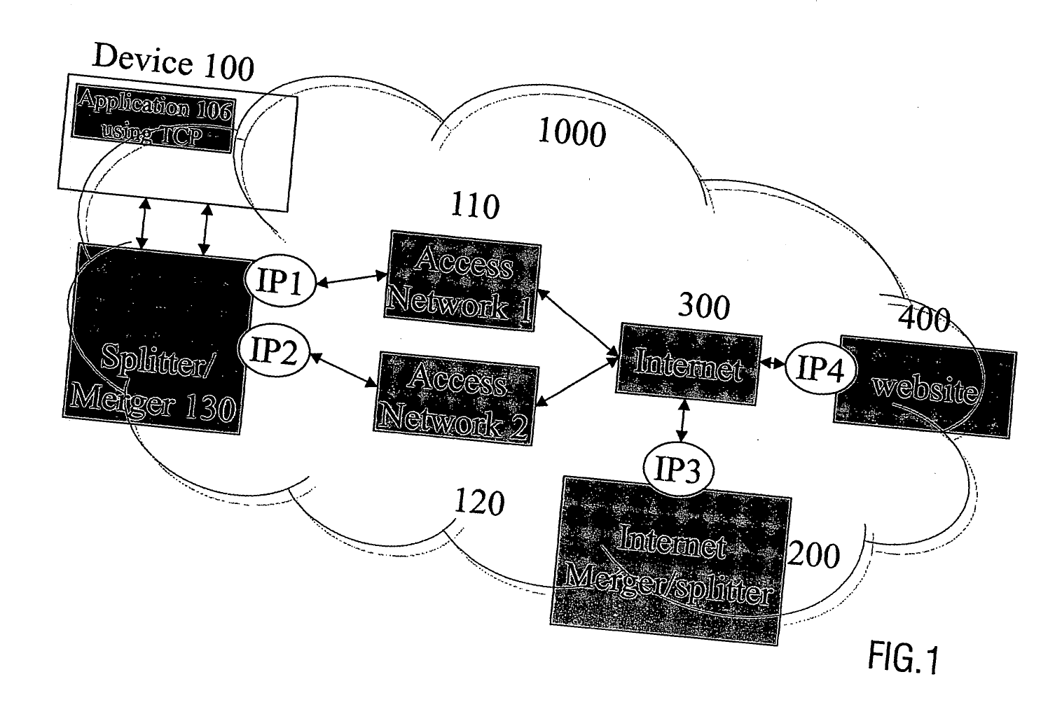

FIG. 1 depicts a basic arrangement of some hardware and software components for use with the method according to the invention;

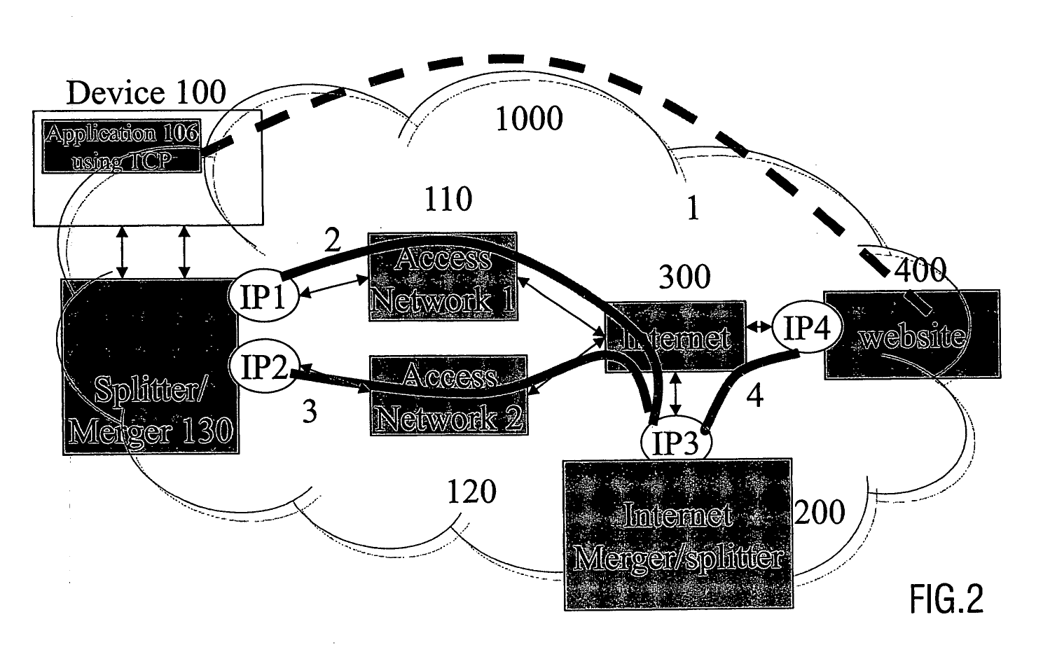

FIG. 2 depicts an overview of the proxied connection 1 between the client device and the server device, the special connection 2, 3 between the splitting/merging device which interoperates with the client device and the merging/splitting component on the internet, and the connection 4 between the merging/splitting component and the server device, which connections 1-4 come into operation during application of the method according to the invention;

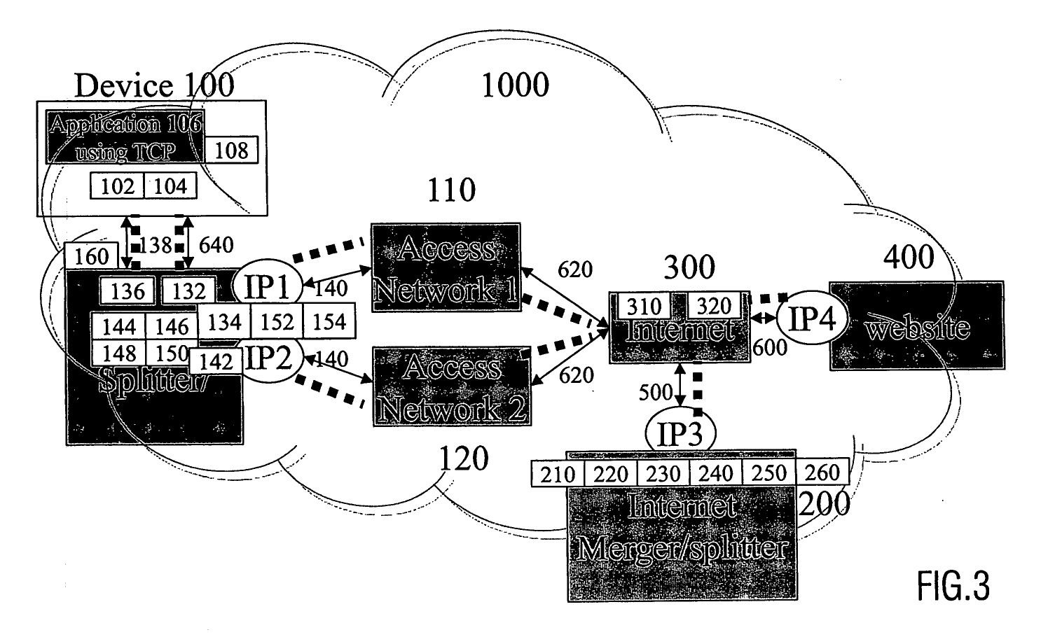

FIG. 3 depicts a detailed arrangement of the hardware and software components according to FIG. 1; and

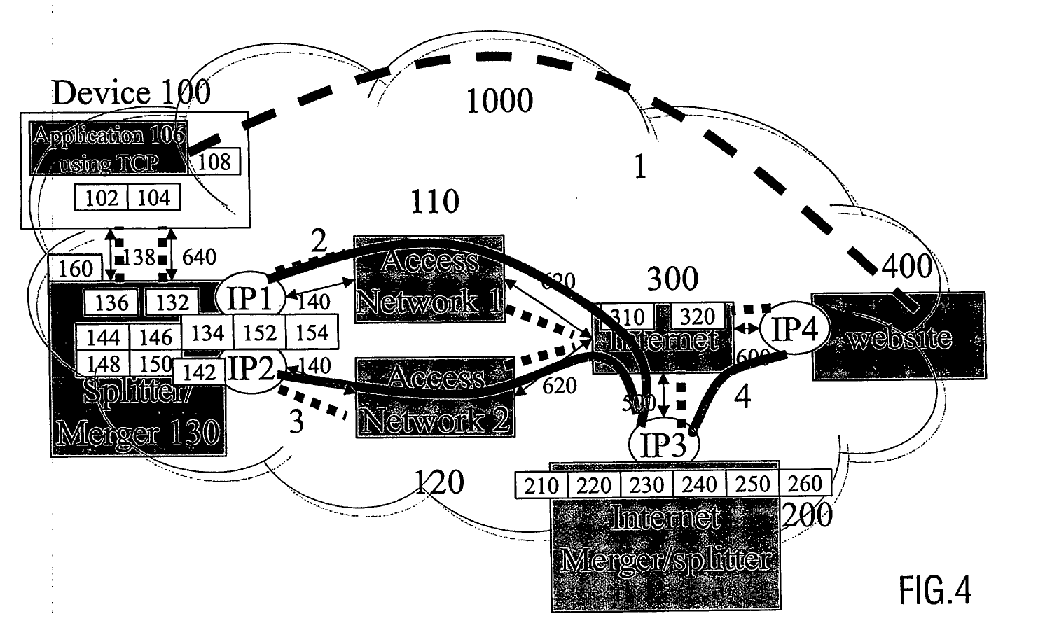

FIG. 4 depicts an overlay of FIG. 2 on the detailed arrangement according to FIG. 3.

FIG. 1 shows a client device 100 that connects to multiple access networks. FIG. 3 shows the arrangement of FIG. 1 in further detail. The client device 100 is controlled by a component 102 which hosts a command protocol 104. There are two networks in this scheme: access network 1 (AN1) and access network 2 (AN2); the number of networks can be generalized to N. Both access networks provide the device 100 with access to the global internet. The client device 100 has IP address IP1 on access network AN1, and IP address IP2 on access network AN2.

The client device 100 interacts with two components. First, there is a splitter/merger component 130. This (software) component 130 splits messages 138 coming from an application 106 that makes use of e.g. TCP, for example by accessing the Winsock API under Windows, or the java.net package in Java, or Berkeley sockets in Unix, over the available access networks. Similarly, it merges incoming messages 620 from the access networks into a single stream. For the purposes of the application 106 running on the client device 100, it is as if there is a single TCP connection, through the use of proxying means 108. Second, there is a splitter/merger component 200 which is external with respect to the first location and which is connected to the Internet 300. This component 200 is an Internet host (for example a specialised web server; however it could be a similar component as shown here (peer-to-peer networking)) that merges the previously split stream (140), and sends this (500) on towards the server end in the second location of the connection. Similarly, any information (500) going towards the device 400 in the second location can be split here over the available access networks. The Internet splitter/merger 200 has a single IP address IP3. There are other possible implementations whereby the Internet splitter/merger 200 is duplicated or multiplicated, for example for the purposes of load balancing and/or reliability. A single device can use multiple Internet splitter/mergers; however for a single connection it can only use a single one as a normal connection from the internet splitter/merger device with IP3 to e.g. a normal website with IP4 requires a single IP address at both endpoints.

The method thus entails initiating a connection 1 between the client device 100 and a server device 400 on the internet; creating a special connection 2, 3 over a number of available access networks AN1, AN2 to a merging/splitting component 200 on the internet; creating a connection 4 between the merging/splitting component 200 on the internet and the server device 400 in the second location; splitting traffic 138 from an application 106 running on the client device 100 in the first location itself; transmitting the splitted data packets 140 originating from the client device 100 through a number of IP addresses IP1, IP2 across the internet; when appropriate retransmitting unacknowledged packets or if appropriate switching a retransmission protocol over from one access network to another; merging the streams of packets 140 originating from the client device 100 through a number of IP addresses at the merging/splitting component 200 on the internet; and forwarding the merged streams 500 to the server device 400 in the second location. Any traffic 600 from the server device 400 to the client device 100 follows the above steps in reverse functional order.

The splitter/merger device 130 is shown only at the client end of the connection. It shall be clear that such a device can also be provided for at the server end of the connection.

The splitter/merger device 130 splits outgoing traffic 140 over the available connections 2, 3 depending on progress of transport across each of these connections. The client device 100 comprises means 148 (see FIG. 3) for monitoring any bandwidth available over said separate communication paths 110, 120 as well as means 150 (see FIG. 3) for responding to any change in the available bandwidth. The latter means 150 generate control instructions 152 (see FIG. 3) for use by means 144 (see FIG. 3) for switching the connection at the client end to make maximum use of the available bandwidth. The functions of the splitter/merger device 130 and of the merging/splitting component 200 are symmetric and mirrored if there is both incoming and outgoing traffic. An embodiment of the invention can be implemented transparently if the splitter/merger device 130 is e.g. configured in a firewall or gateway which implements port forwarding. An internet website can function as a merger so that the server device in the second location is kept unaware of the operations of the splitter/merger device 130 in the first location. The splitter/merger device 130 and the merging/splitting component 200 can each be configured for handling one-way traffic or two-way traffic.

FIG. 2 shows the set-up of a number of connections overlaid on the hardware and software components shown in FIG. 1. In this situation, an application in the external splitting/merging device 200 (with IP address IP3) initiates a connection between the client device 100 and an internet host 400 (with IP address IP4). This is indicated as connection 1. Connection 1 is established as follows. The internal splitter/merger device 130 creates a special connection over all available access networks (110, 120) to the Internet merging/splitting component 200 (with IP address IP3). This results in connections 2 and 3. The connections are special since they differ from normal connections in the following ways. First, initially a header is transferred to the Internet merger/splitter 200 (with IP3) that comprises at least the target IP address (IP4). Second, the retransmission protocol is changed to allow retransmission of a lost packet on access network 1 (AN1) over access network 2 (AN2). This is similar to routing protocols used at the IP level. A simple solution is to use normal connections, and within this stream of bits define the following substructure: <packet ID, payload> <packet ID, payload> . . . .

FIG. 3 shows the hardware and software components according to FIG. 1 in further detail. The splitter/merger device 130 comprises means 132 for interoperating with the connection 1; means 134 for creating the special connection 2, 3 over access networks AN1 and AN2; means 136 for splitting traffic 138, which it receives from application 106 running on the client device 100, into splitted data packets 140; means 142 for transmitting data packets 140 through IP1 and IP2 onto merging/splitting component 200; and means 144 for switching the retransmission protocol in service between AN1 and AN2. The merging/splitting component 200 comprises means 210 for merging the data packets 140 it receives into a stream 500; and means 220 for forwarding the merged stream 500 to the server device 400. For the purposes of two-way traffic component 200 may optionally comprise means 230 for receiving a data stream 600 from the server device 400; means 240 for splitting the stream 600 into splitted data packets 620; means 250 for transmitting the packets 620 onto the splitter/merger device 130; and means 260 for switching the retransmission protocol in service between AN1 and AN2. It shall be clear that sending and receiving means of component 200 can alternatively be configured on the internet itself as means 310 and 320, even in combination therewith. For the purposes of two-way traffic the splitter/merger device 130 comprises means 146 for receiving packets (500, if in a single stream; or 620 if in splitted streams) sent to it by the merging/splitting component 200. Device 130 also comprises means 154 for merging any splitted streams 620 it may receive.

FIG. 4 gives a full view of the hardware and software components and the connections between the same which are called into play as described above.

Since packets are sent over multiple access networks, the packet IDs on a second or further connection can skip packets (which have been sent over a first network), and a packet ID can arrive over two networks (if it is retransmitted & delivered later). Alternatively, UDP packages can be used to create any specific protocols which may be required. This will entail re-implementation of much of the functionality already present in TCP.

The aspect of the invention which relates to splitting and merging algorithms is illustrated by way of the following example.

A possible algorithm for the splitter is the following:
1. take N bits of the TCP stream, create package =<x, payload>
2. store package x in buffer
3. send package x over access network n (where the TCP connection on network n is currently not retransmitting/or is broken/or is busy)
4. go to 1, taking the next N bits, and package ID=x+1
+ a change to the TCP retransmission protocol over access network 1 . . . n
-> if data from package x is retransmitted/cannot be delivered, activate following procedure:
retransmitting (package x, access network n)
1. retrieve package x from buffer, retransmit over different access network k
2. cancel retransmission over access network n
-> if data from package x is successfully transmitted (acknowledged in TCP) received (package x)
   1 free buffer of package x

A possible algorithm for the merger is the following:
1. receive N bits from TCP stream, reconstruct package=<x, payload>
2. if (package with lower x not delivered) buffer package
3. else
3.1 pass payload on to next stage, increase delivered number x
3.2 check buffered package x+1 (go back to 3.1 if found, else finished)

The splitter/merger buffering algorithm required is similar to the normal buffering mechanism of TCP itself The main difference is that the packets are received from different 1P addresses.

A following operation relates to a TCP connection between component 200 with IP3 and device 400 with IP4 for the Internet merger, and the application using TCP for the merger in the component 200. Appropriate algorithms are deemed to be known to the skilled person in the art.

Once the Internet merger/splitter 200 has reconstructed (the head of) the bit stream as sent by the application 106 in the device, it creates a TCP connection 4 (which is an ordinary TCP connection), and subsequently sends the bit stream to device 400 with IP4 (the website in the example). The website 400 will receive the bit stream, treating it as a normal TCP connection coming from an Internet Host with IP address IP3. It will respond with a bit stream of its own, and send that to the Internet Merger/Splitter 200. The Internet Merger/Splitter 200 will divide this bit stream into packages (see the splitter functionality described above), and send it over the appropriate available access networks.

These operations are thus mirrored in communication from the device 400 in the second location towards the external Internet Merger/Splitter 200.

Finally, the device 100 in the first location merges the incoming packages originating from the device 400 in the second location, and passes the resulting bit stream on to the application 106. The application 106 will treat it as a normal TCP connection to IP4. Optionally, an interface can be added, such that splitter-aware applications can control whether or not a TCP connection uses the splitter (see above), or whether a TCP connection uses a single network.

It will be clear to the skilled person that the effect of the splitter on IP addresses used is similar to NAT translation: the website 400 in the second location operates as if it communicates with IP3, while the application 106 in the first location itself will operate as if it communicates using IP1 or IP2. Optionally, the “get local IP address” method that is usually present in TCP APIs can return IP3 to the application, such that both the website 400 and the application 106 operate as if they are communicating between IP3 and IP4. Another option is to return IP1, IP2 and IP3 to the application 106. If the application 106 chooses IP1/IP2, then it uses those specific access networks; if it chooses IP3, then it uses the splitter 200 (and does not require NAT). There may be a special interface that allows the application to query the specifics of the IP addresses: e.g. what type of network at hand.

An embodiment of a message sequence comprises the following
1. <internal> application commands a TCP connection from IP1 to IP4
2. device splitter opens TCP+ connections over AN1,AN2 to Internet Merger
3. Internet merger opens TCP connection to IP4
(acknowledges of TCP protocol left out)
4. <internal>application sends N bits over TCP connection
5. <internal>splitter buffers N bits
6. device splitter sends package <1, 0 . . . N/2 bits> over AN1
(now assume AN1 loses the package and after long time-out, retransmits)
7. device splitter sends package <2, N/2 . . . N bits> over AN2
(AN1 did not acknowledge package 1 when splitter is sending package 2.
Assume package 2 arrives & is acknowledged)
8. internet splitter receives package 2 & buffers it
9. device splitter sends package <1, 0 . . . N/2 bits> over AN2
10. internet splitter receives package 1, sends bits 0 . . . N over TCP connection to IP4.

If subsequently access network 2 (AN2) fails or is slow and access network 1 (AN1) is available, a similar message sequence occurs, and the messages again arrive as if a single connection exists.

Finally, the invention also extends to computer programmes, in particular to computer programmes on or in a carrier, adapted for putting the invention into practice. The programme 160 may be in the form of source code, object code, a code intermediate source and object code such as in partially compiled form, or in any other form suitable for use in the implementation of the processes according to the invention. The carrier may be any entity or device capable of carrying the programme. For example, the carrier may comprise a storage medium or it may be a transmissible carrier such as an electrical or optical signal which may be conveyed via electrical or optical cable or by radio or by other means. When the programme is embodied in a signal which may be conveyed directly by a cable or other device or means, the carrier may be constituted by such cable or other device means. Alternatively, the carrier may be an integrated circuit in which the programme is embedded, the integrated circuit being adapted for performing, or for use in the programme, of the relevant process steps.

The general novel and inventive concept described above enables the use of a number of networks in circumventing a congested communication path. The related advantages are that the latency of the network will be low and the bandwidth increased as there will be no need to firstly interact with the merging/splitting component on the internet, and that protocols that have their own IP addresses in the payload will not break.

1. A method of speeding up a relay operation across an internetworking connection, such as a TCP-connection, between a client device in a first location and a server device in a second location in a network which comprises multiple access nodes or communication paths between said client and server devices, which method comprises the use of a command protocol hosted by a controlling component, whereby the method comprises the following operations:
initiating a connection between the client device and the server device on the internet;
creating a special connection over a number of available access networks to a merging/splitting component on the internet;
creating a connection between the merging/splitting component on the internet and the server device in the second location;
splitting traffic from an application running on the client device in the first location itself;
transmitting the splitted data packets originating from the client device through a number of IP addresses across the internet;
when appropriate retransmitting unacknowledged packets or if appropriate switching a retransmission protocol over from one access network to another;
merging the streams of packets originating from the client device through a number of IP addresses at the merging/splitting component on the internet; and
forwarding the merged streams to the server device in the second location;
whereby any traffic from the server device to the client device follows the above steps in reverse functional order.

2. A method of speeding up a relay operation across an internetworking connection according to claim 1, whereby the method further comprises the operation of monitoring the bandwidths over a number of access networks available to the client device with respect to the merging/splitting component on the internet and of responding to any change in the available bandwidth by generating control instructions for switching the connection at the client end for making maximum use of the available bandwidth.

3. A method of speeding up a relay operation across an internetworking connection according to claim 1, whereby there are multiple operations for merging the streams of packets originating from the server device through a number of IP addresses at the merging/splitting component on the internet and for splitting the traffic in the reverse direction.

4. A splitting/merging device suitable for use with a client device in a first location or with a server device in a second location in a method of speeding up a relay operation according to claim 1, whereby the splitting/merging device comprises:
means for interoperating with a connection between the client device and the server device on the internet;
means for creating a special connection over a number of available access networks between the splitting/merging device itself and a merging/splitting component on the internet;
means for splitting traffic from an application running on the client device in the first location into splitted data packets;
means for transmitting splitted data packets across the internet through a number of IP addresses to the merging/splitting component on the internet;
means for switching a retransmission protocol over from one access network to another;
means for merging the splitted data packets received at the merging/splitting component into a merged stream;
means for forwarding the merged stream to the server device in the second location;
optionally means for receiving a data stream from the server device in the second location;
optionally means for splitting the data stream into splitted data packets;
optionally means for transmitting splitted data packets across the internet through a number of IP addresses to the splitting/merging device;
optionally means for switching a retransmission protocol over from one access network to another;
means for receiving the packets transmitted by the merging/splitting component across the internet to the splitting/merging device, and
means for merging any splitted streams of packets transmitted by the merging/splitting component to the splitting/merging device.

5. A splitting/merging device according to claim 4, whereby the device further comprises means for monitoring the bandwidths over a number of access networks available to the client device with respect to the merging/splitting component on the internet and means for responding to any change in the available bandwidth by generating control instructions for switching the connection at the client end for making maximum use of the available bandwidth.

6. A computer programme comprising instructions, which instructions include at least code defining the processes or functions to be performed with respect to splitting traffic from an application running on the client device in the first location itself and monitoring the bandwidths over all access networks available to the client device with respect to the merging/splitting component on the internet for causing a programmable processing apparatus having or being connected to transmission hardware to become operable to execute the splitting/merging and switching operations of the method of switching a connection according to claim 1.

7. A system for speeding up a relay operation across an internetworking connection, such as a TCP connection, between a client device in a first location and a server device in a second location in a network which comprises multiple access nodes or channels between said client and server devices, which system comprises
at its client end:
means for proxying a connection between said client and server devices;
means for creating the proxied connection into multiple separate connections for different communication paths; and
means for routing these separate connections over said different communication paths; and
and intermediate to or at its server end:
means for receiving traffic across said number of different communication paths and/or sending traffic across said different communication paths, respectively;
means for merging said traffic into a merged stream and forwarding the same through a single connection, and/or splitting traffic into different streams, respectively; and
means for forwarding merged traffic to the server device, and forwarding traffic received from the server device onto said means to be forwarded by the latter as a single stream if and when appropriate splitted into traffic across said different communication paths, respectively.

8. A system according to claim 7, whereby the system further comprises
means for monitoring any bandwidth available over said separate communication paths; and
means for responding to any change in the available bandwidth, which means generate control instructions for use by means for switching the TCP connection at the client end to make maximum use of the available bandwidth.
